(19) United States
(12) Patent Application Publication
(10) Pub. No.: US 2007/0257059 A1
(43) Pub. Date: Nov. 8, 2007

(54) Beverage dispenser

(76) Inventor: William C. Stevenson, Chatsworth, CA (US)

Correspondence Address: Christopher J. McDonald;Russ, August & Kabat, Suite 522, 2461 South Clark Street, Arlington, VA, 22202, US

(21) Appl. No.: 11/429,317

(22) Filed: May 8, 2006

(51) Int. Cl. B67D 5/56; B67D 5/60

(52) U.S. Cl. 222/129.4; 222/145.6

(57) ABSTRACT

A beverage dispenser has a water tank to provide water to a mixing manifold. Liquid concentrate stored in a reservoir feeds to the mixing manifold. Downstream of the mixing manifold is a mixing bowl receiving powdered ingredients from a hopper. Pumps such as peristaltic pumps, move the fluid. The whole process is controlled by a microprocessor.

### FIELD OF THE INVENTION

The present field of the invention relates to a single nozzle beverage dispensing machine that may produce a multitude of beverage drinks from a limited source of liquid and dry powder concentrated ingredients. Specifically the beverage dispensing machine may, at the direction of programmable selection switches, dispense beverages which comprise one or more source concentrate ingredients blended with potable water to produce a myriad of beverage types.

### BACKGROUND OF THE INVENTION

Beverage dispensing machines have been present in the marketplace for an extended period of time. Typically they are dispensers of single ingredient beverages such as fruit juices, coffees, teas and carbonated soft drinks.

Presently known beverage dispensing machines typically mix the ingredient concentrate with potable water at the dispense nozzle, producing a single flavor profile from only a single ingredient source. To produce a blended beverage requires the user to first fill a portion of a drinking vessel with an estimated volume of one ingredient beverage, then to add to that volume one or more additional volumes of alternative ingredient beverage to produce a beverage concoction that requires secondary stirring with a spoon or other implement to produce an homogenous mixed beverage.

Other known beverage dispensers mix the ingredient concentrate and potable water in a chamber immediate to the dispense nozzle. The mix chamber may be a specifically designed volume containing fixed vanes or other features that cause turbulence between the ingredient concentrate and potable water to effect thorough blending of the two. Alternatively, the mix chamber may incorporate a powered blade or impeller to more thoroughly blend ingredient concentrate and potable water to produce a finished beverage.

Other known beverage dispensers do mix various dry powder ingredients, such as creamer and sugar for coffee dispensers. However, no known beverage dispensers incorporate both dry powder and liquid concentrate ingredients in their mixing scheme.

It is an inherent weakness of existing known beverage dispensers that they cannot produce a beverage consisting of mixed ingredients from a single dispensing nozzle. The reasons for this weakness are the inability of the dispensing machines to accurately produce a mixed beverage consisting of repeatable ratios of alternative ingredients and potable water. Further, it is considered undesirable to introduce multiple ingredient concentrates to the same mixing chamber or nozzle as this may cause cross contamination of ingredients such as to produce beverages with undesirable flavor characteristics.

It is an object of the invention to provide both individual ingredient beverages and precisely mixed liquid concentrate and dry ingredient beverages using a single dispensing nozzle.

It is another object of the invention to provide a dispenser immune to cross contamination of ingredients, which may produce undesirable flavors in each dispensed beverage.

These and other objects of the invention will become apparent to one of ordinary skill in the art after reading the disclosure of the invention.

### SUMMARY OF THE INVENTION

A beverage dispenser has a water tank to provide water to a mixing manifold. Liquid concentrate stored in a reservoir feeds to the mixing manifold. Downstream of the mixing manifold is a mixing bowl receiving powdered ingredients from a hopper. Pumps such as peristaltic pumps, move the fluid. The whole process is controlled by a microprocessor.

### BRIEF DESCRIPTION OF THE DRAWINGS

FIG. 1 is a block diagram of the beverage dispensing machine;

FIG. 2 is an exploded view showing the various mechanisms which make up the present invention beverage dispensing machine; and

FIG. 3 is an exploded view showing the various mechanisms which make up a second embodiment of the beverage dispensing machine.

### DETAILED DESCRIPTION OF THE INVENTION

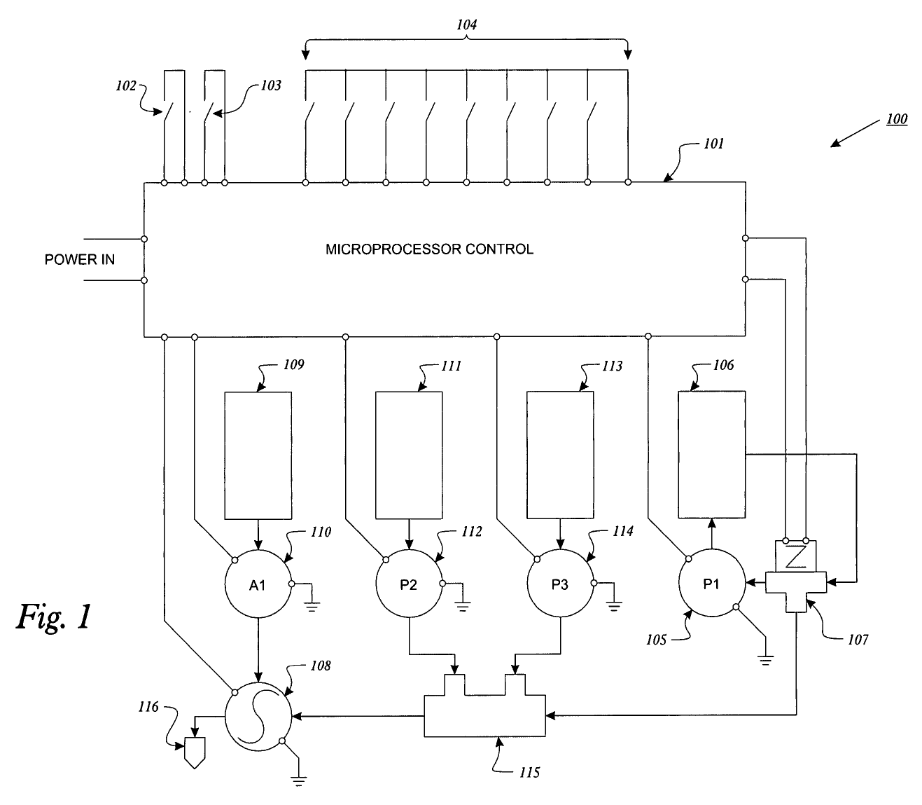

The assembly 100 is seen in FIG. 1. A microprocessor controlled power circuit board 101 provides programmable power commands to control the actions of all electrical elements of the beverage dispensing machine. Switch 102 is the emergency stop command switch, while switch 103 is programmed to supply a definitive total volume of beverage. Selector switches 104 are used to select specific mix programs stored within the microprocessor's memory.

Water pump 105 recirculates potable water contained in reservoir 106 to maintain constant pressure and flow while solenoid valve 107 is closed. Solenoid valve 107 is powered by the microprocessor controlled power circuit board 101 in response to the input of switches 104.

Liquid concentrate ingredients are stored in reservoirs 111 and 113 which supply pumps 112 and 114. The pumps may be any conventional type, such as peristaltic pumps. The pumps are controlled by power input from microprocessor controlled power circuit board 101 in response to the input of switches 104. Dry powder concentrate ingredients are stored in reservoir 109 which supplies auger A1 110 which itself is actuated by power signal from microprocessor controlled power circuit board 101 in response to the input of switches 104.

When pumps 112 and 114 are actuated by power from microprocessor controlled power circuit board 101 in response to the input of switches 104, the output is directed into mix manifold 115 which also simultaneously receives potable water from solenoid valve 107. The potable water and the liquid concentrate ingredients are dynamically blended to produce a beverage stream to mixing bowl 108 Auger A1 110 also supplies mixing bowl 108 with dry powder concentrate ingredients to mixing bowl 108 which then whips them into the beverage stream from mix manifold 115 which then delivers the finished mixed beverage to dispenser nozzle 116.

Programming contained within microprocessor controlled power circuit board 101 directs water pump 105 and the impeller of mixing bowl 108 to continue operating after auger 110 and peristaltic pumps 112 and 114 have shut down. This short period of potable water flow then flushes clean the mix manifold 115 mixing bowl 108 and dispensing nozzle 116 thus keeping the system clean.

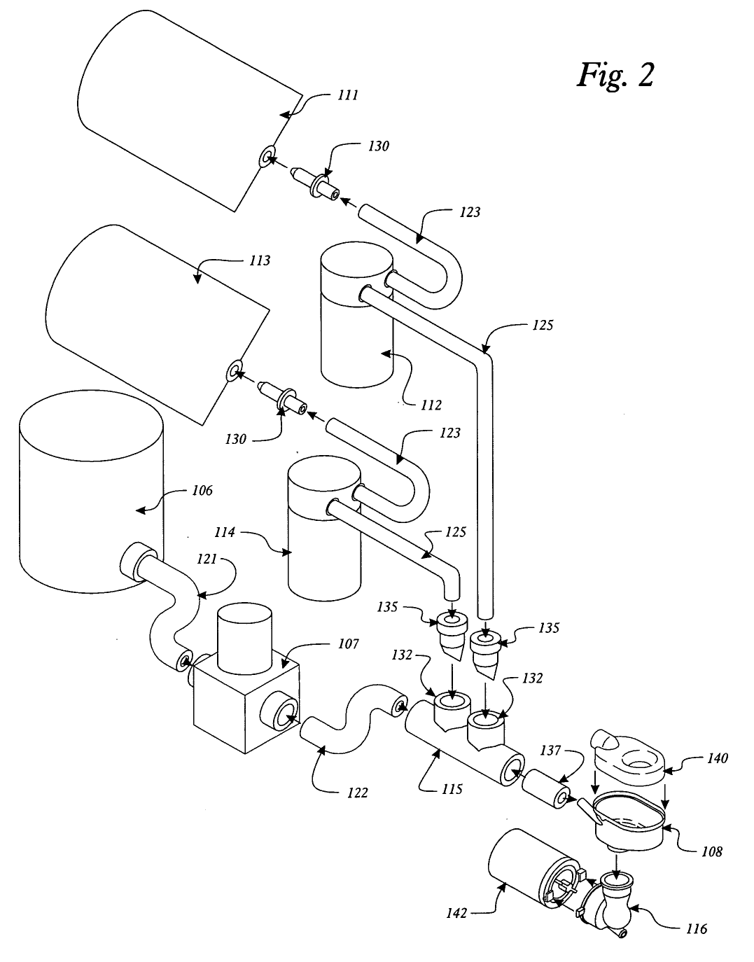

FIG. 2 shows an exploded view of the components comprising the system. Water tank 106 is connected to solenoid valve 107 by a first hose 121. A second hose 122 leads from the solenoid valve to a manifold 115. Liquid concentrate ingredients are supplied to the manifold from reservoirs 111, 113 by hoses 123 extending between the reservoirs and connected thereto by a fitting, such as a bayonet fitting 130. The pumps 112, 114 are connected to the ports 132 on the manifold 115 by hoses 125. A check valve 135 at the junction of the hose 125 and port 132 prevents backflow into the hoses 125. A hose 137 leads from the outlet of the manifold 115 to the mixing bowl 108 which has a cover 140 the contents of the mixing bowl 108 are sent to dispenser 116 which is driven by motor 142.

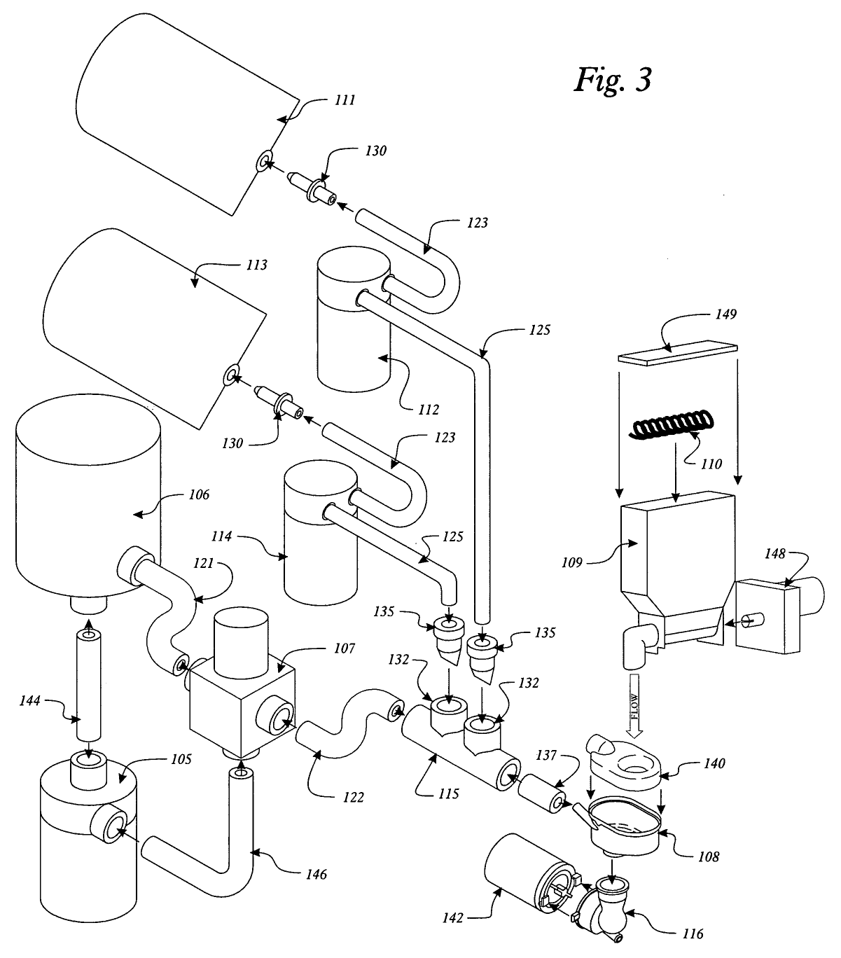

FIG. 3 shows a second embodiment in the invention. Elements are identical to that of FIG. 2. use the same reference numeral and will not be further described here. In this system, the water reservoir 106 is connected to a pump 105 by a hose 144. A second hose 146 leads from the pump 105 to the solenoid valve 107. When the solenoid is not energized, water is recirculated back to the reservoir 106, but upon energizing, water flows to the manifold 115. Dry powder is held within hopper 109 containing the auger 110. Auger 110 is driven by motor 148 to dispense powder from the hopper 109 into the mixing bowl 108. The hopper 109 also has cover 149.

While the invention has been described with reference to preferred embodiments, variations and modifications would be apparent to one of ordinary skill in the art. The invention encompasses such variations and modificaitons.

What is claimed is:

1. A beverage dispenser, comprising
a water tank,
a solenoid valve controlling the flow of water from said water tank,
a mixing manifold receiving water from the water tank,
at least one reservoir having a liquid, the at least one reservoir in fluid communication with the mixing manifold, and
a dispenser receiving the flow from the mixing manifold.

2. The dispenser of claim 1, further comprising
a pump moving fluid from said at least one reservoir to said mixing manifold.

3. The dispenser of claim 2, wherein said pump is a peristaltic pump.

4. The dispenser of claim 1, wherein the at least one reservoir is two reservoirs.

5. The dispenser of claim 1, further comprising
a mixing bowl receiving fluid from the mixing manifold and in fluid communication with said dispenser, and
a hopper connected to the mixing bowl.

6. The dispenser of claim 5, further comprising
an auger in the hopper for moving contents from the hopper.

7. The dispenser of claim 6, further comprising a controller controlling the flow of water and material from the at least one reservoir and hopper.

8. The dispenser of claim 7, wherein said controller is a microprocessor.
